(19) United States
(12) Patent Application Publication
(10) Pub. No.: US 2020/0048941 A1
(43) Pub. Date: Feb. 13, 2020

(54) DOOR UNLOCKING DEVICE OF CONSTRUCTION MACHINE

(71) Applicant: KOBELCO CONSTRUCTION MACHINERY CO., LTD., Hiroshima-shi (JP)

(72) Inventor: Tsuyoshi NODA, Hiroshima (JP)

(73) Assignee: KOBELCO CONSTRUCTION MACHINERY CO., LTD., Hiroshima-shi (JP)

(21) Appl. No.: 16/527,796

(22) Filed: Jul. 31, 2019

(30) Foreign Application Priority Data
Aug. 7, 2018 (JP) 2018-148420

(51) Int. Cl. E05B 83/42; E05B 85/12; E05B 79/16; E05B 85/02

(52) U.S. Cl. CPC E05B 83/42; E05B 85/12; E05Y 2900/531; E05B 85/02; E05Y 2900/518; E05B 79/16

(57) ABSTRACT

A door unlocking device includes: a locking device that locks a door of a cab of a construction machine; an outer handle that receives an operation for unlocking the locking device from outside of the cab; and an inner handle that receives an operation for unlocking the locking device from inside of the cab. The outer handle is configured to perform an unlocking operation on the locking device without pivoting the inner handle, by pulling a link rod and pivoting an unlocking lever as the outer handle receives the operation for unlocking the locking device.

### BACKGROUND

The present invention relates to a door unlocking device of a construction machine.

As a door unlocking device of a construction machine, a technique disclosed in Japanese Patent Application Laid-Open No. 2018-9369 is known. In the technique, an inner handle pivotable about a predetermined pivoting shaft includes: an operation arm part that gives a pivoting operation to the inner handle; an unlocking arm part that unlocks a locking device with the pivoting operation of the inner handle; and a connecting arm part connected to a link rod connected to an outer handle. When the outer handle pivots the inner handle via the link rod with the unlocking operation of the outer handle, the unlocking operation is performed on the locking device.

Meanwhile, a technique disclosed in Japanese Patent No. 4248659 is known. In the technique, a door for opening and closing a side part of a cab of a construction machine is provided with an opening and closing handle, a door opening lock, and a door closing lock. An intermediate remote control unit controls operations of locking the door, opening the door with an outer handle, and opening the door with an inner handle. In this door unlocking device, eight link rods, seven link plates, and five mechanical parts are housed in one door.

However, in the technique disclosed in Japanese Patent Application Laid-Open No. 2018-9369, when an outer lever is operated, an inner lever is pulled by the link rod and inclined. Since there is an unlocking lever between a pivoting shaft of the inner lever and a pivoting shaft of the unlocking lever, directions of inclination are opposite to each other. Therefore, friction always arises at contact portions, which may lead to wear and abrasion of the contact portions depending on the usage frequency and usage method. If wear arises, the wear may develop quickly, significantly deteriorating operation feeling, and in the worst case, functions may be paralyzed, making it difficult to open the door from inside a room.

In the technique disclosed in Japanese Patent No. 4248659, the operations of the outer handle and the inner handle do not interlock with each other, and five components are linearly arranged in a horizontal direction. Front handles and rear locks are connected to each other by the link rods via the intermediate remote control unit, and the assembling operation is extremely complicated and difficult.

An object of the present invention is to provide a door unlocking device that reduces wear of the contact portion between the inner handle and the unlocking lever in the unlocking operation, and maintains excellent operation feeling over a long period of time.

### SUMMARY

The present invention provides a door unlocking device of a construction machine including: a locking device that locks a door of a cab; an outer handle that receives an operation for unlocking the locking device from outside of the cab; and an inner handle that receives an operation for unlocking the locking device from inside of the cab.

The door unlocking device includes: a locking part configured to lock the door; an unlocking lever configured to be pivoted about an unlocking lever pivoting shaft and unlock the locking part when pivoted at a predetermined angle; a link rod connecting the outer handle to the unlocking lever; an abutted part provided on the unlocking lever; and a rod connecting plate provided on the unlocking lever and connected to the link rod connected to the outer handle. The inner handle includes: an operation arm part pivotable about an inner handle pivoting shaft provided in the door; and a pushing plate provided away from the inner handle pivoting shaft, the pushing plate being configured to push the abutted part to pivot the unlocking lever in an identical direction to the inner handle. The outer handle is configured to perform an unlocking operation on the locking part without pivoting the inner handle, by pulling the link rod and pivoting the unlocking lever about the unlocking lever pivoting shaft to the predetermined angle as the outer handle receives an operation for unlocking the locking device.

### BRIEF DESCRIPTION OF THE DRAWINGS

FIG. 1 is a side view of a construction machine according to one embodiment of the present invention;

FIG. 2A is a side view showing an internal structure of a locked door of the construction machine according to the embodiment of the present invention, with an inner panel partially broken;

FIG. 2B is a side view showing the internal structure of the door unlocked by an inner handle of the construction machine according to the embodiment of the present invention;

FIG. 2C is a side view showing the internal structure of the door unlocked by an outer handle of the construction machine according to the embodiment of the present invention;

FIG. 3 is a plan view showing an unlocking device of the construction machine according to the embodiment of the present invention;

FIG. 4 is a rear view showing a configuration of the inner handle and a locking device of the construction machine according to the embodiment of the present invention;

FIG. 5 is a side view showing the configuration of the inner handle and the locking device of the construction machine according to the embodiment of the present invention;

FIG. 6 is a side view of the locking device of the construction machine according to the embodiment of the present invention, when viewed from inside of a cab;

FIG. 7 is a perspective view showing a body portion of the inner handle with an operation knob removed and an unlocking lever of the construction machine according to the embodiment of the present invention;

FIG. 8 is an exploded perspective view showing the unlocking lever and an abutted part of the construction machine according to the embodiment of the present invention; and

FIG. 9 is a perspective view showing a rod connecting plate according to a modification of the present invention.

### DETAILED DESCRIPTION

An embodiment of the present invention will be described below with reference to the drawings. Note that the description of the preferred embodiment below is merely exemplary in nature and is not intended to limit the invention, its applications, or its uses. In some drawings, directions of up and down, front and rear, and left and right are indicated by arrows. Unless otherwise stated, the directions such as up and down will be described according to the directions shown by these arrows.

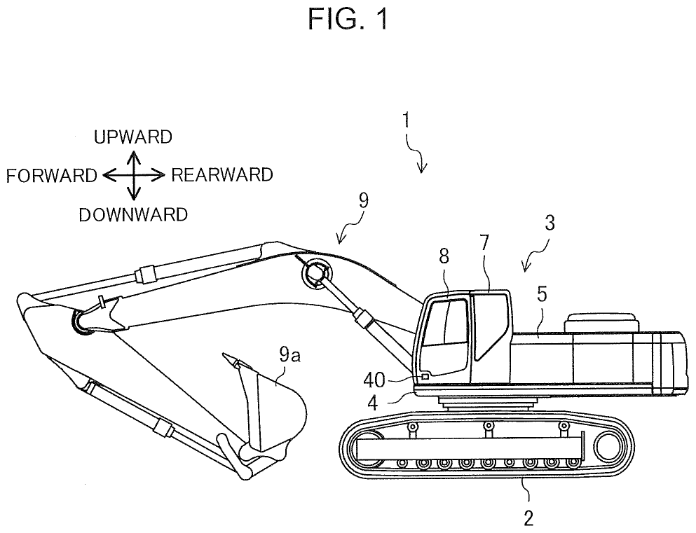

FIG. 1 is a side view of a construction machine 1 according to one embodiment of the present invention. As shown in FIG. 1, the construction machine 1 is, for example, a hydraulic excavator, and includes a crawler-type lower travelling body 2, an upper slewing body 3 rotatably mounted on the lower travelling body 2, a control valve and an engine (not shown), a machine room cover 5, a cab 7, a door 8, and an attachment 9. The attachment 9 for performing work such as digging work is attached to a front central portion of an upper frame 4 of the upper slewing body 3. The attachment 9 includes, for example, a bucket 9a attached to a tip of the attachment 9. The cab 7 is disposed on a left side of the attachment 9 on the upper frame 4. The control valve, the engine, and other components are disposed on a rear side of the upper frame 4, and are covered with the machine room cover 5. The door 8 that can be opened and closed is provided on a left surface of the cab 7. An outer handle 40 is provided at a lower position of a left surface of the door 8 for unlocking the door 8 from outside of the cab 7.

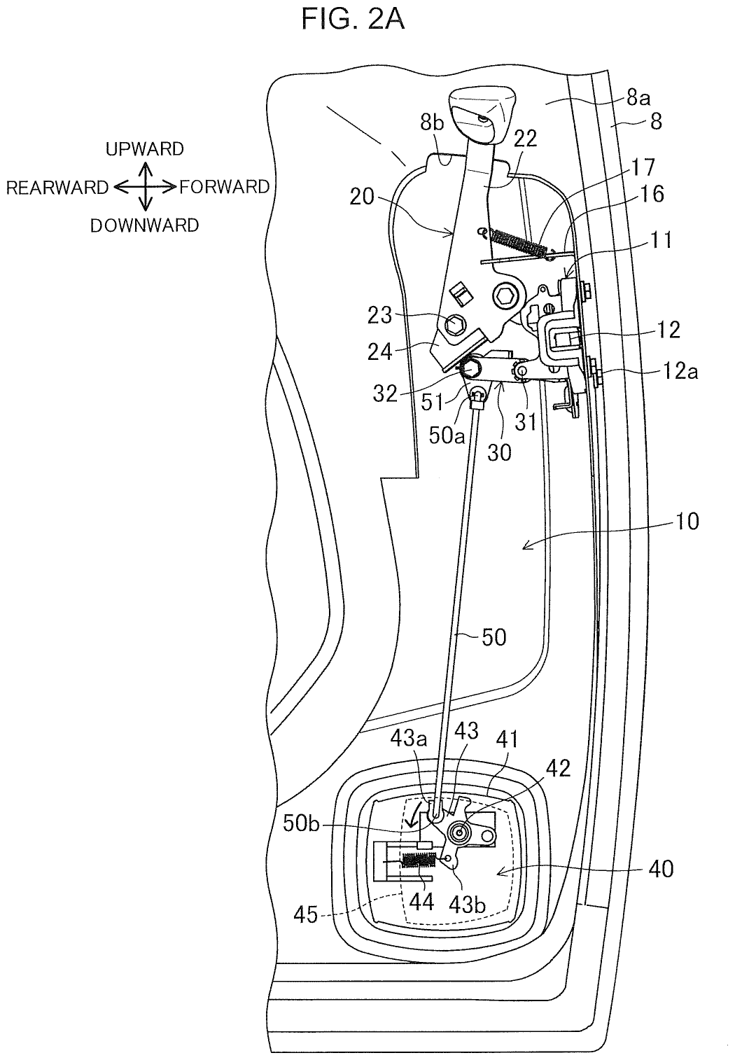

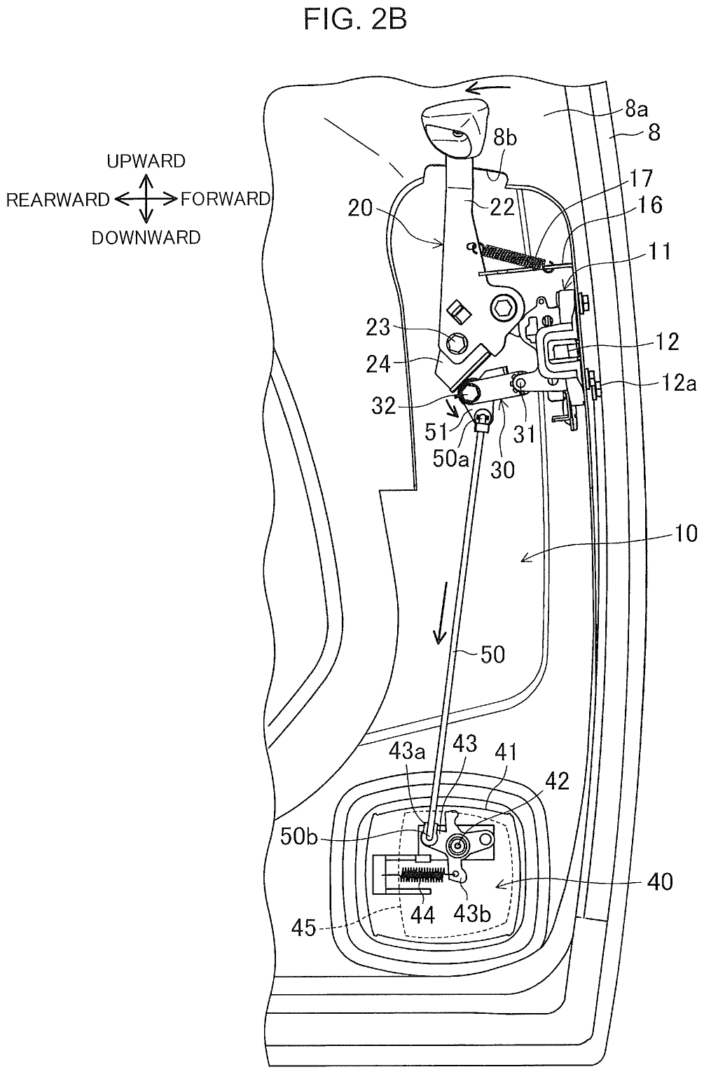

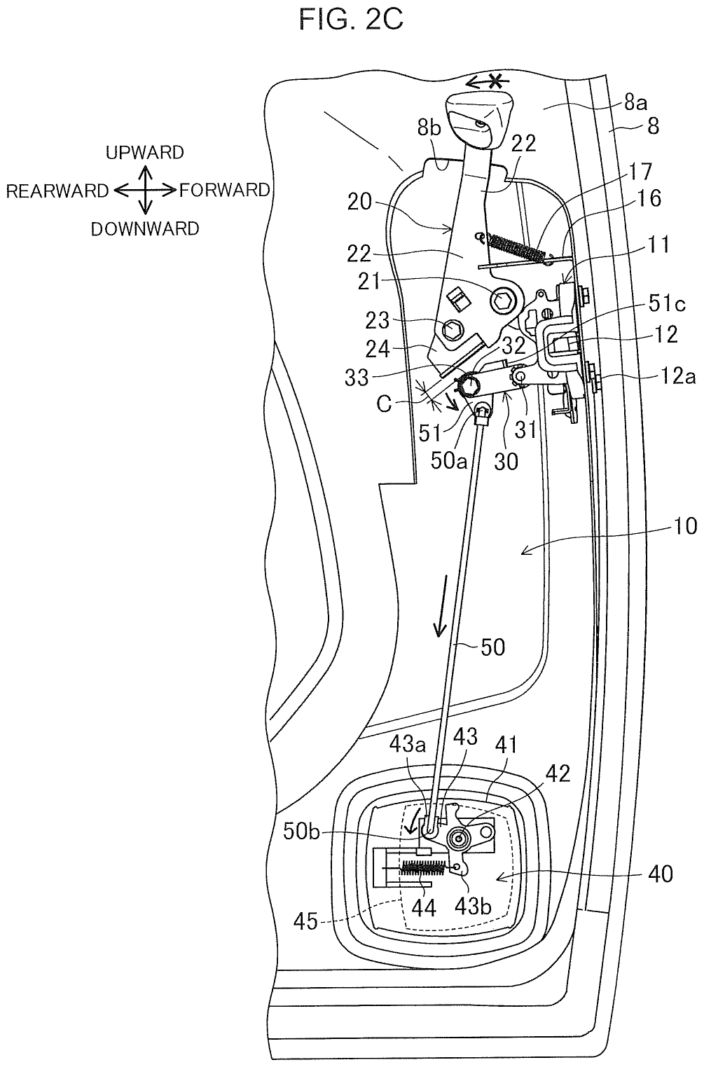

FIG. 2A is a side view showing an internal structure of the locked door 8 of the construction machine 1 according to the present embodiment, with an inner panel 8a partially broken. FIG. 2B is a side view showing the internal structure of the door 8 unlocked by an inner handle 20. FIG. 2C is a side view showing the internal structure of the door 8 unlocked by the outer handle 40.

The construction machine 1 includes a door unlocking device 10. The door unlocking device 10 includes a locking device 11, the inner handle 20, and the outer handle 40.

As shown in FIG. 2A, the locking device 11 for locking the door 8 is built into the door 8. The locking device 11 is interlocked with the door unlocking device 10. The outer handle 40 receives an operation for unlocking the locking device 11 from outside of the cab 7. The inner handle 20 receives an operation for unlocking the locking device 11 from inside of the cab 7.

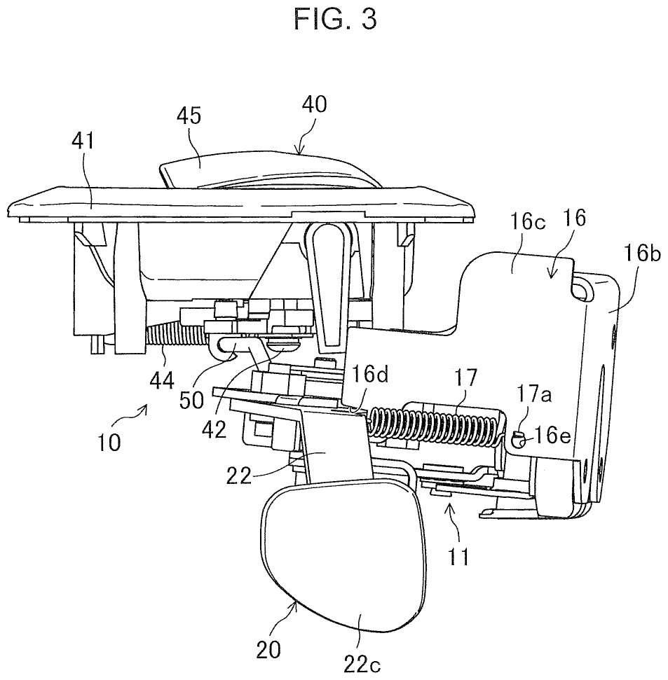

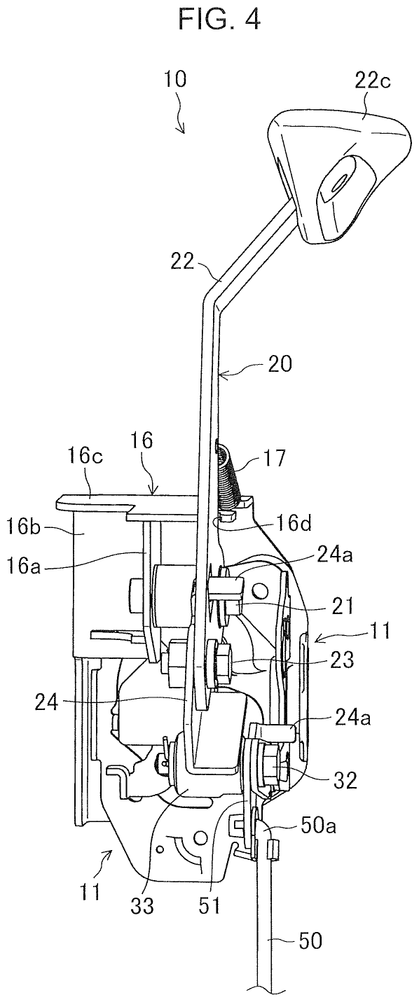

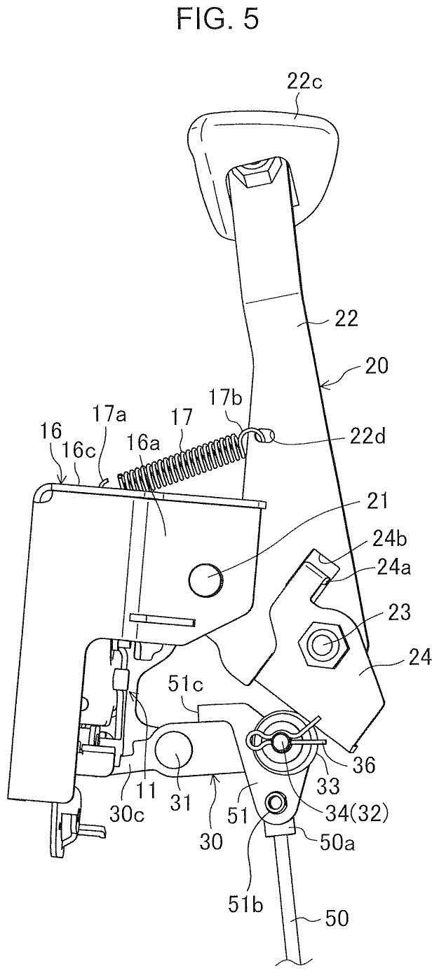

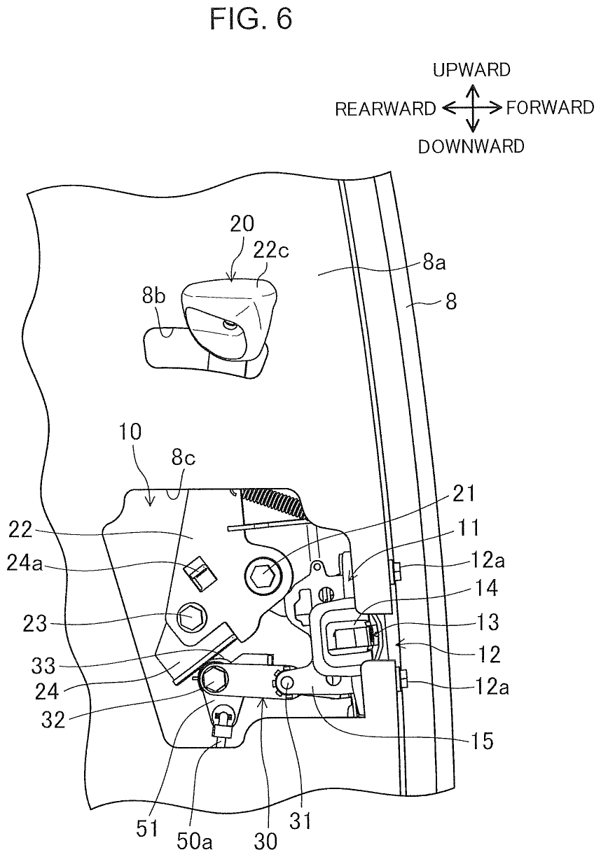

FIG. 3 is a plan view showing the door unlocking device 10 of the construction machine 1 according to the present embodiment. FIG. 4 is a rear view showing a configuration of the inner handle 20 and the locking device 11 of the construction machine 1 according to the present embodiment. FIG. 5 is a side view showing the configuration of the inner handle 20 and the locking device 11 of the construction machine 1 according to the present embodiment. FIG. 6 is a side view of the locking device 11 of the construction machine 1 according to the present embodiment, when viewed from inside of the cab 7.

The door 8 includes a striker 13 (FIG. 6) and a locking device body 16 (FIGS. 3 and 4). The inner handle 20 and the locking device 11 are held by the locking device body 16 (FIG. 2A). The locking device 11 includes a known locking part 12 for locking the door 8, an unlocking lever 30, an abutted roller 33 (abutted part), a link rod 50 (FIG. 2A), and a rod connecting plate 51 (FIGS. 4, 5, and 6). The striker 13 is provided near the door 8 in the cab 7. The locking part 12 includes a pair of upper and lower striker catches 14 that grips and locks the striker 13, and a locking body part 15 that supports the striker catches 14 such that the striker catches 14 can be opened and closed (FIG. 6). The unlocking lever 30 is provided so as to be pivoted up and down about an unlocking lever pivoting shaft 31 provided in a lower portion of the locking body part 15. The unlocking lever 30 is configured to unlock the locking part 12 when the unlocking lever 30 is pivoted at a predetermined angle about the unlocking lever pivoting shaft 31.

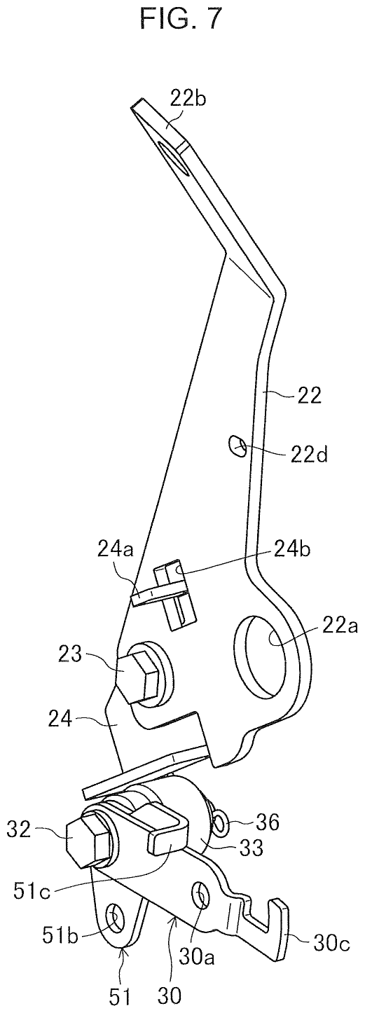

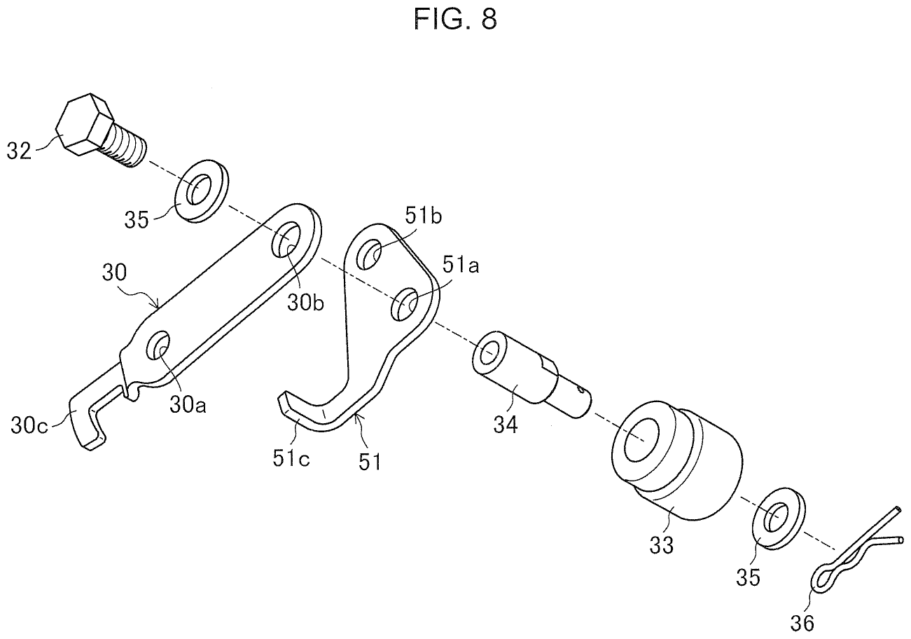

FIG. 7 is a perspective view showing an operation arm part 22 with an operation knob 22c (FIG. 4) removed and the unlocking lever 30 of the construction machine 1 according to the present embodiment. FIG. 8 is an exploded perspective view showing the unlocking lever 30 and the abutted roller 33 (abutted part) of the construction machine 1 according to the present embodiment.

As shown in an enlarged manner in FIG. 8, the unlocking lever 30 includes, for example, a plate-shaped member, and includes a proximal end side through hole 30a into which the unlocking lever pivoting shaft 31 is inserted, a distal end side through hole 30b into which an unlocking lever bolt 32 rotatably supporting the abutted roller 33 is inserted, and a protruding portion 30c. The unlocking lever 30 is configured to unlock the locking part 12 with the L-shaped protruding portion 30c provided on a locking part 12 side. As shown in FIG. 8, the unlocking lever 30 is provided with (connected to) the abutted roller 33 and the rod connecting plate 51.

The unlocking lever bolt 32 is connected to a roller rotation shaft 34 that pivotably supports the abutted roller 33 that serves as a roller-shaped abutted part. The unlocking lever bolt 32 is inserted into a supported through hole 51a of the rod connecting plate 51 to which an upper end 50a of the link rod 50 to be described later is connected and the rod connecting plate 51 is pivotably supported by the unlocking lever bolt 32. A washer 35 is sandwiched between the roller rotation shaft 34 and the unlocking lever bolt 32, and another washer 35 is externally fitted to a tip of the roller rotation shaft 34 inserted into the abutted roller 33. Inserting a split pin 36 into a hole portion opened at the tip of the roller rotation shaft 34 will prevent detachment of the roller rotation shaft 34 from the abutted roller 33 (prevent coming off). The rod connecting plate 51 connected to the link rod 50 is pivotably connected to the roller rotation shaft 34. As shown in FIG. 5 and other views, the upper end 50a of the link rod 50 connected to the outer handle 40 is pivotably connected to a connecting through hole 51b of the rod connecting plate 51 (FIG. 7). An unlocking lever pressing portion 51c that is bent so as to press the unlocking lever 30 from above is formed at a position away from (position on an opposite side of) the connecting through hole 51b when viewed from the supported through hole 51a of the rod connecting plate 51 (FIG. 8).

As shown in FIGS. 3 and 4, the locking device body 16 formed by, for example, bending a steel plate includes a left wall 16a, a front wall 16b extending rightward from a front edge of the left wall 16a, and an upper wall 16c extending across an upper edge of the left wall 16a and an upper edge of the front wall 16b. An inner handle pivoting shaft 21 extending rightward and pivotably supporting the inner handle 20 is provided on a right surface of the left wall 16a of FIG. 4. As shown in FIG. 6 and other views, a central position of the inner handle pivoting shaft 21 is above a central position of the unlocking lever pivoting shaft 31. The door unlocking device 10 is configured such that a pushing plate 24 can easily push down the abutted roller 33 about the unlocking lever pivoting shaft 31 when the inner handle 20 receives an operation for unlocking the locking device 11. Since the inner handle 20 and the unlocking lever 30 can be vertically arranged side by side, the door unlocking device 10 including the inner handle 20 and the unlocking lever 30 has a configuration that is compact and easy to install.

The inner handle 20 includes the operation aim part 22 and the pushing plate 24 (FIG. 7). The operation arm part 22 is pivotable about the inner handle pivoting shaft 21 provided in the door 8. The pushing plate 24 can push the abutted roller 33 to pivot the unlocking lever 30 in the same direction as the inner handle 20.

The inner handle pivoting shaft 21 (FIG. 6) is inserted into a through hole 22a (FIG. 7) on the proximal end side of the operation arm part 22 extending upward so as to pivot the inner handle 20. The operation knob 22c (FIG. 4) on which the operator's hand is put is attached to a tip 22b of the operation arm part 22. A spring through hole 22d is formed at an upper and lower intermediate position of the operation arm part 22. The other end 17b of a tension coil spring 17, to be described later, is connected to the spring through hole 22d.

The pushing plate 24 is supported at a position away from the inner handle pivoting shaft 21 on the proximal end side of the operation arm part 22 so as to be pivotable about a plate pivoting shaft 23. The pushing plate 24 abuts on the abutted roller 33 so as to push one end of the unlocking lever 30 and pivot the unlocking lever 30 in the same direction as the inner handle 20 as described above. The plate pivoting shaft 23 of the inner handle 20 can fix the pushing plate 24 in a state where the pushing plate 24 is adjusted at a predetermined pivoting angle about the plate pivoting shaft 23 with respect to the operation arm part 22. As shown in FIGS. 5 and 7, the pushing plate 24 has, for example, a structure in which a steel plate is bent, and a plate-side engagement protrusion 24a is formed through bending at a position away from the plate pivoting shaft 23. Meanwhile, for example, a substantially rectangular engaged long hole 24b is formed at the proximal end side of the operation arm part 22 of the inner handle 20. The plate-side engagement protrusion 24a is engaged with the rectangular engaged long hole 24b and regulates the pivoting angle of the plate-side engagement protrusion 24a. The plate-side engagement protrusion 24a moves along the longitudinal direction of the plate-side engagement protrusion 24a within a range of the engaged long hole 24b, thereby making it possible to fix the pushing plate 24 in a state adjusted to the predetermined pivoting angle with respect to the inner handle 20 (operation arm part 22). Specifically, it is possible to fix the pushing plate 24 to the inner handle 20 by tightening the bolt constituting the plate pivoting shaft 23 (fixing member) with the pushing plate 24 pivoted to an appropriate position. Thus, it is possible to easily improve operation feeling of the inner handle 20 by finely adjusting the position of the pushing plate 24.

Meanwhile, as shown in FIG. 2A and other views, the outer handle 40 is configured to perform an unlocking operation on the locking part 12 without pivoting the inner handle 20 by pulling the link rod 50 and pivoting (pulling down) the unlocking lever 30 about the unlocking lever pivoting shaft 31 as the outer handle 40 receives an operation for unlocking the locking device 11. Specifically, the outer handle 40 includes a mounting bracket 41 provided inside the door 8, an outer pivoting shaft 42 provided on the mounting bracket 41 and extending in a vehicle width direction, an outer operating lever 43 pivotably supported about the outer pivoting shaft 42, an outer pressing spring 44 for pressing the outer operating lever 43 in a locking direction (clockwise in FIG. 2A), and an outer grip portion 45 for pivoting the outer operating lever 43 in an unlocking direction by being pulled forward by a worker from outside of the cab 7.

The outer operating lever 43 includes a connecting portion 43a connected to a lower end 50b of the link rod 50 connecting the inner handle 20 to the outer handle 40, and a spring hooking portion 43b by which the outer pressing spring 44 is locked. The outer operating lever 43 pivots counterclockwise in FIG. 2A by the worker pulling the outer grip portion 45 forward. Accordingly, as shown in FIG. 2C, as the link rod 50 is pulled downward, only the unlocking lever 30 pivots in conjunction with the link rod 50 without pivoting the inner handle 20.

As shown in FIGS. 3 and 4, the inner handle pivoting shaft 21 is pivotably supported by the locking device body 16 of the locking device 11. A handle slit 16d is formed in the locking device body 16 so as to avoid a pivot trajectory of the inner handle 20 and to receive the inner handle 20. On an extension line of a direction in which the handle slit 16d extends, a spring connection hole 16e (locking portion) is provided that serves as a connection point of one end 17a of the tension coil spring 17 (pressing member) that presses the operation arm part 22 so as to hold the inner handle 20 at a predetermined angle about the inner handle pivoting shaft 21. As described above, the other end 17b (other end portion) of the tension coil spring 17 on the opposite side of the one end 17a (one end portion) is locked by the operation arm part 22 of the inner handle 20 (FIG. 5).

Note that the front wall 16b (FIG. 4) of the locking device body 16 is fastened together by a fastening bolt 12a in a state sandwiched between the inner panel 8a of the door 8 (FIG. 6) and the locking body part 15 of the locking device 11 (FIG. 6). Accordingly, the locking device body 16 is attached to the door 8. At this time, the striker catches 14 can be opened and closed at right positions of the locking body part 15, and are disposed at positions where the striker catches 14 are engaged with the striker 13 when the door 8 is closed.

As shown in FIG. 6, an opening hole 8b and a guide hole 8c are formed in the inner panel 8a of the door 8. The opening hole 8b is used for assembly and maintenance of the locking device 11 and the inner handle 20. The operation arm part 22 of the inner handle 20 is inserted into the guide hole 8c to allow pivoting of the operation arm part 22 in the front-rear direction. After assembly of the inner handle 20 is completed, the opening hole 8b is closed by a closing plate (not shown) with only the striker catches 14 of the locking device 11 exposed.

### Operation of Door Unlocking Device

To unlock the locking device 11, as shown in FIG. 2B, the operation arm part 22 is pulled rearward to push the pushing plate 24 against the abutted roller 33 against pressing force of the tension coil spring 17. Then, the unlocking lever 30 pivots counterclockwise about the unlocking lever pivoting shaft 31, and the locking part 12 is unlocked by the protruding portion 30c (FIG. 5). At this time, since the inner handle 20 and the unlocking lever 30 pivot in the same direction, it is easy to operate the inner handle 20, and wear is unlikely to arise at the contact point between the pushing plate 24 and the abutted roller 33. Since the abutted part includes the rotatable abutted roller 33, friction on the pushing plate 24 can be minimized, and the worker can operate the inner handle 20 smoothly. Furthermore, since the roller rotation shaft 34 can also be used as the pivoting shaft of the rod connecting plate 51, the number of parts of the locking device 11 (door unlocking device 10) is reduced, resulting in a compact configuration.

Since the tension coil spring 17 is disposed on the extension line of the handle slit 16d, after the locking device 11 is unlocked, the inner handle 20 smoothly returns into the handle slit 16d after the worker operates the inner handle 20, resulting in the state shown in FIG. 2A.

Meanwhile, as shown in FIG. 2C, when the unlocking operation is performed by operating the outer grip portion 45 of the outer handle 40, the outer operating lever 43 pivots counterclockwise, and the link rod 50 is pulled downward accordingly. Then, the unlocking lever pressing portion 51c of the rod connecting plate 51 (FIG. 7) presses the unlocking lever 30, and the unlocking lever 30 pivots counterclockwise about the unlocking lever pivoting shaft 31. Then, the protruding portion 30c of the unlocking lever 30 unlocks the locking part 12. At this time, as shown in FIG. 2A, the pushing plate 24 of the inner handle 20 may somewhat push the abutted roller 33 of the unlocking lever 30 by operating the inner handle 20, but the pushing plate 24 is not directly connected to the abutted roller 33. Since the inner handle 20 is held at a predetermined angle by the tension coil spring 17, the inner handle 20 does not move and stays at a predetermined angle and is not drawn by the link rod 50 when the outer handle 40 is operated. Therefore, a gap C is generated between the pushing plate 24 and the abutted roller 33 (FIG. 2C). The unlocking operation of the locking part 12 is performed without the inner handle 20 being pivoted. Thus, wear of a contact surface between the pushing plate 24 of the inner handle 20 and the abutted roller 33 of the unlocking lever 30 is kept at a minimum level.

Therefore, the door unlocking device 10 of the construction machine 1 according to the present embodiment can reduce a wear risk of the contact portion between the inner handle 20 and the unlocking lever 30 in the unlocking operation with a relatively simple configuration, and maintain excellent operation feeling over a long period.

### Modification

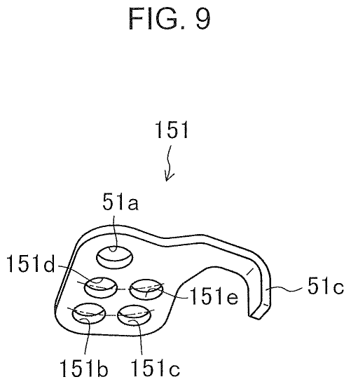

FIG. 9 is a view showing a modification of the present invention, which differs from the above embodiment in that the configuration of a rod connecting plate 151 is different. Note that in this modification, the same parts as in FIGS. 1 to 8 are denoted with the same reference symbols, and detailed descriptions thereof will be omitted.

That is, in the rod connecting plate 151, the supported through hole 51a and the unlocking lever pressing portion 51c are formed as in the above embodiment.

Meanwhile, in the present modification, a plurality of connecting through holes 151b, 151c, 151d, and 151e is formed. Timing of unlocking the locking part 12 can be changed by connecting the upper end 50a of the link rod 50 to a different position among the plurality of connecting through holes 151b, 151c, 151d, and 151e. That is, the timing of unlocking the locking part 12 is different between a case where one end of the link rod 50 is connected to one connecting through hole among the plurality of connecting through holes, and a case where one end of the link rod 50 is connected to another connecting through hole different from the one connecting through hole among the plurality of connecting through holes. With this configuration, a pivoting angle of the rod connecting plate 151 with respect to an operation amount of the outer handle 40 and the inner handle 20 will change depending on the position of the connecting through hole, allowing the unlocking timing to be adjusted with a simple configuration. In case of emergency, the worker can hook a rod-shaped member (not shown) into a remaining connecting through hole among the plurality of connecting through holes 151b, 151c, 151d, and 151e, pivot the rod connecting plate 51, pivot the unlocking lever 30, and unlock the locking part 12. In this case as well, the inner handle 20 is not pivoted, and thus the unlocking operation in case of emergency is easy.

### (Other Embodiments)

The present invention may be configured as follows with respect to the above embodiment.

That is, in the above embodiment, the abutted part includes the abutted roller, but may not include a roller. For example, the abutted part may include a member made of a metal material or resin material that has high wear resistance and does not rotate.

In the above embodiment, the pushing plate 24 is provided separately from the operation arm part 22, but a bent portion on the proximal end side of the operation arm part 22 may abut on the abutted part.

In the above embodiment, the construction machine is a hydraulic excavator, but is not particularly limited as long as the construction machine is equipped with a door in a cab.

The present invention provides a door unlocking device of a construction machine including: a locking device that locks a door of a cab of a construction machine; an outer handle that receives an operation for unlocking the locking device from outside of the cab; and an inner handle that receives an operation for unlocking the locking device from inside of the cab. The door unlocking device includes: a locking part configured to lock the door; an unlocking lever configured to he pivoted about an unlocking lever pivoting shaft and unlock the locking part when pivoted at a predetermined angle; a link rod connecting the outer handle to the unlocking lever; an abutted part provided on the unlocking lever; and a rod connecting plate provided on the unlocking lever and connected to the link rod connected to the outer handle. The inner handle includes: an operation arm part pivotable about an inner handle pivoting shaft provided in the door; and a pushing plate provided away from the inner handle pivoting shaft, the pushing plate configured to push the abutted part to pivot the unlocking lever in an identical direction to the inner handle. The outer handle is configured to perform an unlocking operation on the locking part without pivoting the inner handle, by pulling the link rod and pivoting the unlocking lever about the unlocking lever pivoting shaft to the predetermined angle as the outer handle receives an operation for unlocking the locking device.

With the above configuration, when the worker performs the unlocking operation with the outer handle, the link rod is pulled to pivot the unlocking lever. At this time, the pushing plate of the inner handle may push the abutted part of the unlocking lever, but the inner handle is not pulled by the link rod because the pushing plate is not connected to the abutted part. Therefore, the unlocking operation of the locking part is performed without pivoting the inner handle. Thus, wear of the contact surface between the pushing plate of the inner handle and the abutted part of the unlocking lever can be kept at a minimum level.

In the above configuration, preferably, a central position of the inner handle pivoting shaft is above a central position of the unlocking lever pivoting shaft, when the inner handle receives the operation for unlocking the locking device, the pushing plate pushes down the abutted part about the unlocking lever pivoting shaft to pivot the unlocking lever about the unlocking lever pivoting shaft to the predetermined angle, and when the outer handle receives the operation for unlocking the locking device, the link rod pulls down the unlocking lever about the unlocking lever pivoting shaft to pivot the unlocking lever about the unlocking lever pivoting shaft to the predetermined angle.

With the above configuration, since the inner handle and the unlocking lever can be vertically arranged side by side, the door unlocking device can be compact and easily assembled in a small space.

In the above configuration, preferably, the abutted part is an abutted roller rotatably supported by a roller rotation shaft provided in the unlocking lever, and the rod connecting plate connected to the link rod is pivotably connected to the roller rotation shaft.

With the above configuration, since the abutted part includes the roller, friction on the pushing plate is minimized, and the inner handle can be operated smoothly. Since the roller rotation shaft can also function as the pivoting shaft of the rod connecting plate, the number of parts is reduced and the configuration is compact.

In the above configuration, preferably, a plurality of connecting through holes is formed in the rod connecting plate, and timing of unlocking the locking part is different between a case where one end of the link rod is connected to a first connecting through hole of the plurality of connecting through holes, and a case where the one end of the link rod is connected to a second connecting through hole different from the first connecting through hole of the plurality of connecting through holes.

With the above configuration, the timing of unlocking can he adjusted with a simple configuration.

In the above configuration, preferably, the pushing plate includes: a plate pivoting shaft pivotably supported by the operation arm part; and a plate-side engagement protrusion) disposed at a position away from the plate pivoting shaft, an engaged long hole with which the plate-side engagement protrusion is engaged is formed in the operation arm part, the engaged long hole regulating a pivoting angle of the pushing plate about the plate pivoting shaft with respect to the operation arm part, and the inner handle further includes a fixing member configured to fix the pushing plate at a predetermined pivoting angle about the plate pivoting shaft with respect to the operation arm part.

With the above configuration, by finely adjusting the position of the pushing plate, the operation feeling of the inner handle can be easily improved.

In the above configuration, preferably, the locking device includes a locking device body, the inner handle pivoting shaft is pivotably supported by the locking device body, a handle slit extending along a pivot trajectory of the inner handle and receiving the inner handle is formed in the locking device body, and the door unlocking device further comprises a pressing member including: a first end locked by a locking portion disposed on an extension line of a direction in which the handle slit extends in the locking device body; and a second end locked by the operation arm part of the inner handle, the pressing member pressing the operation arm part to hold the inner handle at a predetermined angle about the inner handle pivoting shaft.

With the above configuration, since the pressing member is disposed on the extension line of the handle slit, the inner handle can smoothly return to the predetermined position in the handle slit after the worker operates the inner handle. Since the inner handle is held at a predetermined angle by the pressing member, the inner handle is maintained at a predetermined angle when the outer handle is operated.

As described above, the present invention has a configuration in which, by pulling the link rod to pivot the unlocking lever with the unlocking operation of the outer handle, the worker performs the unlocking operation on the locking part without pivoting the inner handle. With the relatively simple configuration, the wear risk of the contact portion between the inner handle and the unlocking lever in the unlocking operation can be reduced, and excellent operation feeling can be maintained for a long time.

This application is based on Japanese Patent Application No. 2018-148420 filed in Aug. 7, 2018 to the Japanese Patent Office, the contents of which are incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should he construed as being included therein.

1. A door unlocking device of a construction machine, the door unlocking device comprising:
a locking device configured to lock a door of a cab of the construction machine;
an outer handle configured to receive an operation for unlocking the locking device from outside of the cab; and
an inner handle configured to receive an operation for unlocking the locking device from inside of the cab, wherein
the locking device includes:
a locking part configured to lock the door;
an unlocking lever configured to be pivoted about an unlocking lever pivoting shaft and unlock the locking part when pivoted at a predetermined angle;
a link rod connecting the outer handle to the unlocking lever;
an abutted part provided on the unlocking lever; and
rod connecting plate provided on the unlocking lever and connected to the link rod connected to the outer handle,
inner handle includes:
an operation arm part pivotable about an inner handle pivoting shaft provided in the door; and
a pushing plate provided away from the inner handle pivoting shaft, the pushing plate being configured to push the abutted part to pivot the unlocking lever in an identical direction to the inner handle, and
the outer handle is configured to perform an unlocking operation on the locking part without pivoting the inner handle, by pulling the link rod and pivoting the unlocking lever about the unlocking lever pivoting shaft to the predetermined angle as the outer handle receives an operation for unlocking the locking device.

2. The door unlocking device of a construction machine according to claim 1, wherein
a central position of the inner handle pivoting shaft is above a central position of the unlocking lever pivoting shaft,
when the inner handle receives the operation for unlocking the locking device, the pushing plate pushes down the abutted part to pivot the unlocking lever about the unlocking lever pivoting shaft to the predetermined angle, and
when the outer handle receives the operation for unlocking the locking device, the link rod pulls down the unlocking lever to pivot the unlocking lever about the unlocking lever pivoting shaft to the predetermined angle.

3. The door unlocking device of a construction machine according to claim 1, wherein
the abutted part is an abutted roller rotatably supported by a roller rotation shaft provided in the unlocking lever, and
the rod connecting plate connected to the link rod is pivotably connected to the roller rotation shaft.

4. The door unlocking device of a construction machine according to claim 3, wherein
a plurality of connecting through holes is formed in the rod connecting plate, and
timing of unlocking the locking part is different between a case where one end of the link rod is connected to a first connecting through hole of the plurality of connecting through holes, and a case where the one end of the link rod is connected to a second connecting through hole different from the first connecting through hole of the plurality of connecting through holes.

5. The door unlocking device of a construction machine according to claim 1, wherein
the pushing plate includes:
a plate pivoting shaft pivotably supported by the operation arm part; and
a plate-side engagement protrusion disposed at a position away from the plate pivoting shaft,
an engaged long hole with which the plate-side engagement protrusion is engaged is formed in the operation arm part, the engaged long hole regulating a pivoting angle of the pushing plate about the plate pivoting shaft with respect to the operation arm part, and
the inner handle further includes a fixing member configured to fix the pushing plate at a predetermined pivoting angle about the plate pivoting shaft with respect to the operation arm part.

6. The door unlocking device of a construction machine according to claim 1, wherein
the locking device includes a locking device body,
the inner handle pivoting shaft is pivotably supported by the locking device body,
a handle slit extending along a pivot trajectory of the inner handle and receiving the inner handle is formed in the locking device body, and
the door unlocking device further comprises a pressing member including: a first end locked by a locking portion disposed on an extension line of a direction in which the handle slit extends in the locking device body; and a second end locked by the operation arm part of the inner handle, the pressing member pressing the operation arm part to hold the inner handle at a predetermined angle about the inner handle pivoting shaft.
